(19) United States
(12) Patent Application Publication
(10) Pub. No.: US 2012/0196992 A1
(43) Pub. Date: Aug. 2, 2012

(54) SYNERGISTIC ANTISTATIC COMPOSITIONS

(75) Inventors: Tania Weyland, Widensolen (FR); Frank Oliver Heinrich Pirrung, Grunstadt (DE); Franck Baradel, Freland (FR)

(73) Assignee: BASF SE, LUDWIGSHAFEN (DE)

(21) Appl. No.: 13/496,506

(22) PCT Filed: Sep. 20, 2010
(86) PCT No.: PCT/EP10/63765

§ 371 Date: Apr. 23, 2012

(30) Foreign Application Priority Data
Sep. 23, 2009 (EP) 09171061.6

(51) Int. Cl. C08L 77/00

(52) U.S. Cl. 525/92 A

(57) ABSTRACT

The instant invention pertains to a synergistic antistatic composition comprising a thermoplastic or elastomeric polymeric substrate, a polymeric phosphoric acid mono or diester or a mixture thereof and a polyetheresteramide. Further aspects of the invention are a process for the preparation of antistatic thermoplastic or elastomeric polymeric substrates and the use of the polymeric phosphoric acid mono or diester or mixtures thereof as antistatic additive for thermoplastic or elastomeric polymers.

The instant invention pertains to a synergistic antistatic composition comprising a thermoplastic or elastomeric polymeric substrate, a polymeric phosphoric acid mono or diester or a mixture thereof and a polyetheresteramide. Further aspects of the invention are a process for the preparation of antistatic thermoplastic or elastomeric polymeric substrates and the use of the polymeric phosphoric acid mono or diester or mixtures thereof as antistatic additive for thermoplastic or elastomeric polymers.

It is known that polymers are subject to a strong electrostatic charge and that charges, once applied, can be discharged only slowly because of the low electrical conductivity of polymers. Rapid discharging is required not only for aesthetic reasons but also, in many cases, for reasons of safety. The following adverse effects in use may be mentioned: soiling of polymer surfaces, electrical shocks to persons touching polymers, disruption of production caused by the adhesion of film webs, destruction of electronic components, lump formation in polymer powders, and sparking, caused by charges being too high, with subsequent ignition, which has already frequently resulted in serious explosions.

It is known to limit static charging by the addition of additives that improve surface conductivity, but such substances have the disadvantage of being ineffective in practice when atmospheric humidity is low. It is therefore better to use additives that are effective at low atmospheric humidity, which can usually be achieved by increasing the volume conductivity. The known substances for increasing volume conductivity, for example carbon black or metal powder, however, alter the mechanical properties of the polymers and cannot be used for transparent polymers. In addition, there is an increasing requirement for additives to be ecologically unobjectionable.

Further details relating to antistatic additives and the mechanism of static charging may be found, for example, in the “Plastics Additives Handbook”, editors R. Gächter and H. Müller, Hanser Verlag, 3rd edition, 1990, pages 749-775.

U.S. Pat. Nos. 5,604,284, 5,652,326 and 5,886,098 disclose antistatic thermoplastic resin compositions comprising a certain polyetheresteramide additive.

U.S. Pat. No. 5,965,206 discloses compositions comprising thermoplastic or elastomeric polymer substrates and an antistatic mixture in the form of contiguous fibers. A component of the antistatic fibers may be for example polyetheresteramides.

It has now been found that polymer substrates are made more efficiently antistatic by the incorporation therein of at least one antistatic agent selected from the group consisting of the polyetheresteramides, and at least one phosphoric acid mono or diester of a copolymeric alcohol residue or mixtures thereof.

One aspect of the invention is an antistatic polymer composition comprising
a) a thermoplastic or elastomeric polymer substrate and
b) a combination of
   i) at least one antistatic additive selected from the group consisting of the polyetheresteramides and
   ii) a phosphoric acid mono or diester from a mono- or di-alcohol residue which is copolymerized with an alkylene oxide or/and a lactam or/and a lactone or/and a hydroxyl functional multiacid or mixtures thereof;
with the proviso that polyoxyethylene lauryl ether phosphoric acid is excluded.

Examples of thermoplastic or elastomeric polymers are listed below.

1. Polymers of mono- and di-olefins, for example polypropylene, polyisobutylene, poly-butene-1, poly-4-methylpentene-1, polyisoprene or polybutadiene and also polymerisates of cyclo-olefins, such as, for example, of cyclopentene or norbornene; and also polyethylene (which may optionally be cross-linked), for example high density polyethylene (HDPE), low density polyethylene (LDPE), linear low density polyethylene (LLDPE), branched low density polyethylene (BLDPE).

Polyolefins, that is to say polymers of mono-olefins, as mentioned by way of example in the preceding paragraph, especially polyethylene and polypropylene, can be prepared by various processes, especially by the following methods:

a) radically (usually at high pressure and high temperature);

b) by means of catalysts, the catalyst usually containing one or more metals of group IVb, Vb, VIb or VIII. Those metals generally have one or more ligands, such as oxides, halides, alcoholates, esters, ethers, amines, alkyls, alkenyls and/or aryls, which may be either p- or s-coordinated. Those metal complexes may be free or fixed to carriers, such as, for example, to activated magnesium chloride, titanium(III) chloride, aluminium oxide or silicon oxide. Those catalysts may be soluble or insoluble in the polymerisation medium. The catalysts can be active as such in the polymerisation or further activators may be used, such as, for example, metal alkyls, metal hydrides, metal alkyl halides, metal alkyl oxides or metal alkyl oxanes, the metals being elements of group(s) Ia, IIa and/or IIIa. The activators may be modified, for example, with further ester, ether, amine or silyl ether groups. Those catalyst systems are usually known as Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of mono- and di-olefins with one another or with other vinyl monomers, such as, for example, ethylene/propylene copolymers, linear low density polyethylene (LLDPE) and mixtures thereof with low density polyethylene (LDPE), propylene/butene-1 copolymers, propylene/isobutylene copolymers, ethylene/butene-1 copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and copolymers thereof with carbon monoxide, or ethylene/acrylic acid copolymers and salts thereof (ionomers), and also terpolymers of ethylene with propylene and a diene, such as hexadiene, dicyclopentadiene or ethylidenenorbornene; and also mixtures of such copolymers with one another or with polymers mentioned under 1), for example polypropylene-ethylene/propylene copolymers, LDPE-ethylene/vinyl acetate copolymers, LDPE-ethylene/acrylic acid copolymers, LLDPE-ethylene/vinyl acetate copolymers, LLDPE-ethylene/acrylic acid copolymers and alternately or randomly structured polyalkylene-carbon monoxide copolymers and mixtures thereof with other polymers, such as, for example, polyamides.

4. Hydrocarbon resins (for example C₅-C₉) including hydrogenated modifications thereof (for example tackifier resins) and mixtures of polyalkylenes and starch.

5. Polystyrene, poly(p-methylstyrene), poly(α-methylstyrene).

6. Copolymers of styrene or α-methylstyrene with dienes or acrylic derivatives, such as, for example, styrene/butadiene, styrene/acrylonitrile, styrene/alkyl methacrylate, styrene/butadiene/alkyl acrylate and methacrylate, styrene/maleic acid anhydride, styrene/acrylonitrile/methyl acrylate; high-impact-strength mixtures consisting of styrene copolymers and another polymer, such as, for example, a polyacrylate, a diene polymer or an ethylene/propylene/diene terpolymer; and also block copolymers of styrene, such as, for example, styrene/butadiene/styrene, styrene/isoprene/styrene, styrene/ethylene-butylene/styrene or styrene/ethylene-propylene/styrene.

7. Graft copolymers of styrene or α-methylstyrene, such as, for example, styrene on poly-butadiene, styrene on polybutadiene/styrene or polybutadiene/acrylonitrile copolymers, styrene and acrylonitrile (or methacrylonitrile) on polybutadiene; styrene, acrylonitrile and methyl methacrylate on polybutadiene; styrene and maleic acid anhydride on polybutadiene; styrene, acrylonitrile and maleic acid anhydride or maleic acid imide on polybutadiene; styrene and maleic acid imide on polybutadiene, styrene and alkyl acrylates or alkyl methacrylates on polybutadiene, styrene and acrylonitrile on ethylene/propylene/diene terpolymers, styrene and acrylonitrile on polyalkyl acrylates or polyalkyl methacrylates, styrene and acrylonitrile on acrylate/butadiene copolymers, and mixtures thereof with the copolymers mentioned under 6), such as those known, for example, as so-called ABS, MBS, ASA or AES polymers.

8. Halogen-containing polymers, such as, for example, polychloroprene, chlorocaoutchouc, chlorinated or chlorosulfonated polyethylene, copolymers of ethylene and chlorinated ethylene, epichlorohydrin homo- and co-polymers, especially polymers of halogen-containing vinyl compounds, such as, for example, polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate.

9. Polymers derived from α,β-unsaturated acids and derivatives thereof, such as polyacrylates and polymethacrylates, or polymethyl methacrylates, polyacrylamides and polyacrylonitriles impact-resistant-modified with butyl acrylate.

10. Copolymers of the monomers mentioned under 9) with one another or with other unsaturated monomers, such as, for example, acrylonitrile/butadiene copolymers, acrylonitrile/alkyl acrylate copolymers, acrylonitrile/alkoxyalkyl acrylate copolymers, acrylonitrile/vinyl halide copolymers or acrylonitrile/alkyl methacrylate/butadiene terpolymers.

11. Polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins mentioned in Point 1.

12. Homo- and co-polymers of cyclic ethers, such as polyalkylene glycols, polyethylene oxide, polypropylene oxide or copolymers thereof with bisglycidyl ethers.

13. Polyacetals, such as polyoxymethylene, and also those polyoxymethylenes which contain comonomers such as, for example, ethylene oxide; polyacetals that are modified with thermoplastic polyurethanes, acrylates or MBS.

14. Polyphenylene oxides and sulfides and mixtures thereof with styrene polymers or polyamides.

15. Polyurethanes derived from polyethers, polyesters and polybutadienes having terminal hydroxy groups on the one hand and aliphatic or aromatic polyisocyanates on the other hand, and their initial products.

16. Polyamides and copolyamides derived from diamines and dicarboxylic acids and/or from aminocarboxylic acids or the corresponding lactams, such as polyamide 4, polyamide 6, polyamide 6,6, 6,10, 6,9, 6,12, 4,6, 12,12, polyamide 11, polyamide 12, aromatic polyamides derived from m-xylene, diamine and adipic acid; polyamides prepared from hexamethylenediamine and iso- and/or tere-phthalic acid and optionally an elastomer as modifier, for example poly-2,4,4-trimethylhexamethyleneterephthalamide or poly-m-phenylene-isophthalamide. Block copolymers of the above-mentioned polyamides with polyolefins, olefin copolymers, ionomers or chemically bonded or grafted elastomers; or with polyethers, such as, for example, with polyethylene glycol, polypropylene glycol or polytetramethylene glycol. Also polyamides or copolyamides modified with EPDM or ABS; and polyamides condensed during processing (“RIM polyamide systems”).

17. Polyureas, polyimides, polyamide imides and polybenzimidazoles.

18. Polyesters derived from dicarboxylic acids and dialcohols and/or from hydroxycarboxylic acids or the corresponding lactones, such as polyethylene terephthalate, polybutylene terephthalate, poly-1,4-dimethylolcyclohexane terephthalate, polyhydroxybenzoates, and also block polyether esters derived from polyethers with hydroxy terminal groups; and also polyesters modified with polycarbonates or MBS.

19. Polycarbonates and polyester carbonates.

20. Polysulfones, polyether sulfones and polyether ketones.

21. Natural polymers, such as natural rubber, or polymer-homologously chemically modified derivatives of cellulose, such as cellulose acetates, propionates and butyrates, and the cellulose ethers, such as methyl cellulose.

22. Mixtures (polyblends) of the afore-mentioned polymers, such as, for example, PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6,6 and copolymers, PA/HDPE, PA/PP, PA/PPO.

For example component (a) is a polyolefin, a polystyrene, a copolymer of acrylonitrile/butadiene/styrene (ABS), a polymer of α,β-unsaturated acids, a halogen-containing polymer, a homo- or co-polymer of cyclic ethers, a polymer of unsaturated alcohols and amines, a polyacetal, a polyphenylene oxide, a polyurethane, a polyamide, a polyester, a polyurea, a polycarbonate, a polysulfone or natural rubber.

Preferably component (a) is a polyolefin, a polystyrene, an acrylonitrile/butadiene/styrene (ABS) copolymer, a polymer of α,β-unsaturated acids, a halogen-containing polymer or a homo- or co-polymer of cyclic ethers.

More preferably component (a) is polyvinyl chloride (PVC), polyethylene, polystyrene or polypropylene.

Polyetheresteramides are known as antistatic additives per se and are commercially available, for example under the trade name Pebax® or Pelestat®.

U.S. Pat. No. 3,839,245 discloses antistatic polyamides, polyesters and polyolefins that comprise aliphatic polyetheresteramides.

U.S. Pat. Nos. 4,230,838 and 4,332,920 teach a method for the preparation of moldable and extrudable aliphatic polyetheresteramides.

U.S. Pat. No. 5,096,995 discloses polyetheresteramides with aromatic backbones.

U.S. Pat. Nos. 5,604,284, 5,652,326 and 5,886,098 disclose antistatic thermoplastic resin compositions comprising a certain polyetheresteramide additive.

Suitable polyetheresteramides are aliphatic or aromatic polyetheresteramides, preferably aliphatic polyetheresteramides.

In a general sense, the polyetheresteramides known in the art and of this invention comprise polyamide and polyether segments linked together with ester groups. They are prepared for example from polyamines, polybasic carboxylic acids and polyoxyalkylene glycols. In the simplest sense, they are a copolymer of a polyamide with carboxylic end groups (a dicarboxylic polyamide) and a polyoxyalkylene glycol.

The aromatic polyetheresteramides are described similarly, and additionally comprise an aromatic portion. For the purposes of this invention, “aromatic” polyetherester amides are those where an aromatic portion is introduced as part of the polyether (polyol) segment, for example through a bisphenol (infra).

Polyamides with carboxylic end groups are prepared by conventional methods, for example by the polycondensation of a lactam, polycondensation of an amino acid or the polycondensation of a diacid and a diamine. Carried out in the presence of an excess of an organic diacid, these polycondensations produce polyamides with carboxylic end groups.

The polyamides are prepared for example from lactams or amino acids of from 4 to 14 carbon atoms.

Examples of lactams are caprolactam, oenantholactam, dodecalactam, undecanolactam, dodecanolactam, caprylolactam and laurolactam.

Examples of amino carboxylic acids are ω-amino caproic acid, ω-aminoenanthic acid, ω-aminocaprylic acid, ω-aminoperalgonic acid, ω-aminocapric acid, 11-amino-undecanoic acid and 12-aminododecanoic acid.

The polyamide may be the product of the condensation of a dicarboxylic acid and a diamine such as polyamide 6,6, 6,9, 6,10, 6,12, and 9,6; the products of hexamethylenediamine with adipic acid, azelaic acid, sebacic acid, 1,12-dodecanedioic acid and of nonamethylene diamine with adipic acid.

Suitable diamines include ethylenediamine, propylenediamine, tetramethylenediamine, pentamethylenediamine, hexamethylenediamine, heptamethylene diamine, octamethylene diamine, decamethylenediamine, hexadecamethylenediamine, 3,4,5-trimethylhexamethylenediamine, dimer diamine (diamines of dimeric acids obtained by the polymerization of oleic acid or similar unsaturated acids), p-xylylenediamine, p-phenylenediamine, 1-methyl-2,4-diaminobenzene, N,N′-dimethylphenylenediamine, 1,4-diaminocyclohexane, bis-(p-aminocyclohexyl)methane, N,N′-dimethyl-1,4-diaminocyclohexane, piperizine, 2,5-dimethylpiperazine, isophoronediamine, N-oleyl-1,3-diaminopropane, N-coco-1,3-propylenediamine, methylimino-bis-propylamine, and the like.

Suitable diacids are carboxylic diacids, for example straight or branched chain aliphatic or cycloaliphatic carboxylic diacids, or aromatic diacids having from 4 to 56 carbon atoms, or example from 6 to 20 carbon atoms, for example succinic acid, adipic acid, suberic acid, glutaric acid, pimelic acid, azelaic acid, sebacic acid, undecanedioic acid, dodecanedioic acid, brassylic acid, thapsic acid, dimer acids obtained by the polymerization of unsaturated fatty acids, terephthalic acid, isophthalic acid, phthalic acid, bibenzoic acid, naphthalene dicarboxylic acid, 3-sulfoisophthalic acid alkali metal salt, 1,4-cyclohexane dicarboxylic acid, dicyclohexyl-4,4′-dicarboxylic acid, and the like. Aromatic diacids may be substituted with one or more other substituents such as halogen, for example chlorine or bromine, or alkyl or alkoxy groups of from 1 to 8 carbon atoms, or sulfoxyl.

The polyether segments are prepared from polyoxyalkylene glycols. Polyoxyalkylene glycols are for example polyethylene glycol and polypropylene glycol.

The polyether segments are linear or branched and are for example polyoxyethylene, polyoxypropylene, polyoxybutylene, polyoxyethylenepropylene, polyoxytetramethylene, polyoxydecamethylene, mixtures thereof, or copolyethers thereof.

The number average molecular weight of the polyoxyalkylene glycol sections (the polyether segments) of the polyetheresteramide copolymers is from about 200 to about 6,000, for example from about 400 to about 3,000. The number average molecular weight of the dicarboxylic polyamide sections (the polyamide segments) is from about 200 to about 15,000, for example from about 300 to about 10,000, or from about 500 to about 5,000.

For example the polyetheresteramide consists essentially of residues derived from (1) a polyamide oligomer having carboxylic end groups and having a number average molecular weight of from about 200 to about 15,000 and (2) a polyoxyalkylene glycol having a number average molecular weight of from about 200 to about 6,000.

It is also possible that the polyetheresteramide is part of a mixture. This is, for example, described in U.S. Pat. No. 5,965,206. Such mixtures are, for example, commercially available under the trade name Irgastat®.

For example the polyetheresteramide is part of a mixture comprising

a) 0-80 parts, preferred 20-80 parts of a fibrous polyamide

b) 100-15, preferred 80-20 parts of a polyetherester amide and

c) 0-5, preferred 0.5-5 parts of an ionic compound selected from the group consisting of the alkaline metal salt of acetic acid, trifluoroacetic acid, methanesulfonic acid, trifluoromethane-sulfonic acid, dodecylbenzene sulfonic acid, toluenesulfonicacid, alkylsulfonic acids and ether sulfonic acids, LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF6)₂ and Ca(CF₃SO₃) and NaClO₄,

wherein the sum of components a), b) and c) being 100 parts.

Preferably the polyetheresteramide is part of a mixture comprising

a) 20-80 parts of a fibrous polyamide

b) 80-20 parts of a polyetherester amide and

c) 0.5-5 parts of an ionic compound selected from the group consisting of the alkaline metal salt of acetic acid, trifluoroacetic acid, methanesulfonic acid, trifluoromethane-sulfonic acid, dodecylbenzene sulfonic acid, toluenesulfonicacid, alkylsulfonic acids and ether sulfonic acids, LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF6)₂ and Ca(CF₃SO₃) and NaClO₄,

wherein the sum of components a), b) and c) being 100 parts.

In another embodiment the polyetheresteramide is part of a mixture comprising

a) 20-80 parts of a fibrous polyamide

b) 80-20 parts of a polyetherester amide and

c) 1-5 parts of NaClO₄; wherein the sum of components a), b) and c) being 100 parts.

Polymeric compounds which are polymeric phosphoric acid mono or diesters or mixtures thereof comprising a mono- or di-alcohol residue which is copolymerized with an alkylene oxide or/and a lactam or/and a lactone or/and a diacid are per se known and commercially available as dispersants from Byk Ind. or Ciba Inc. Such dispersants are, for example described in EP 0 417 490 and in WO 2005/085261.

The European Patent EP 0417 490 B1 (Byk-Chemie) describes phosphoric acid esters and their salts corresponding to the formula (HO)₃₋ₙ—PO—(OR)ₙ wherein R is an aliphatic, cycloaliphatic and/or aromatic residue containing at least one ether oxygen (—O—) and at least one carboxylic acid ester group (—COO—) and/or urethane group (—NHCOO—) without Zerewitinoff hydrogen. As an example a compound of the following formula: Alkyl-[O(CH₂)ₓ]_{z}—[O—C═O(CH₂)ₓ]_{y}—O—P═O(OH)₂ is disclosed.

The European Patent EP765356 B1 (Zeneca) describes a dispersant obtainable by reacting a polyethylene glycol with a hydroxycarboxylic acid and/or with an alkylene oxide to form a polymeric diol and phosphating the diol.

For example the phosphoric acid mono or diester comprising a mono- or di-alcohol residue which is copolymerized with an alkylene oxide or/and a lactam or/and a lactone or/and a hydroxyl functional multiacid is of the general formula I,

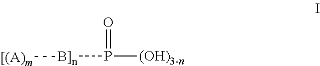

wherein

A is a monohydroxyl residue derived from
C₁-C₂₀-alkyl-(AO)x-OH or Acyl-(AO)x-OH; or
C₁-C₂₀-alkyl -(AO)x-(HA)y-OH or Acyl-(AO)x-(HA)y-OH; or
C₁-C₂₀-alkyl -(AO)x-(AA-AO)y-OH or Acyl-(AO)x-(AA-AO)y-OH; or
MO-(HA)y-OH or MO-(AA-AO)y-OH; wherein
   Acyl is an aromatic carboxylic acid residue or a saturated or unsaturated fatty acid residue;
   AO is a polyC₂-C₄alkyleneglycol residue,
   HA is a hydroxycarboxylic acid or a lactone thereof,
   AA is a dicarboxylic acid,
   MO is a monoalcohol,
   x is 1 to 250,
   y is 1 to 250,
B is a mono-, di-, tri- or polyhydroxy di-, tri- or multi-carboxylic acid residue which is linked via the hydroxy group to the phosphoric acid and via one of the carboxylic acid groups to the monohydroxyl residue [A], the remaining carboxylic acid group(s) is/are free or is/are esterified with a further monohydroxyl residue [A], resulting in branched esters;
n is 1-2;
m is 1-4.

Dispersants of this type are, for example, described in WO 2005/085261.

A schematic representation of further suitable structures is given below.

For example the composition contains a polymeric phosphoric acid mono or diester which is a compound of formulae (Ia), (IIa), (IIb), (IIIa), (IVa) or (Va)

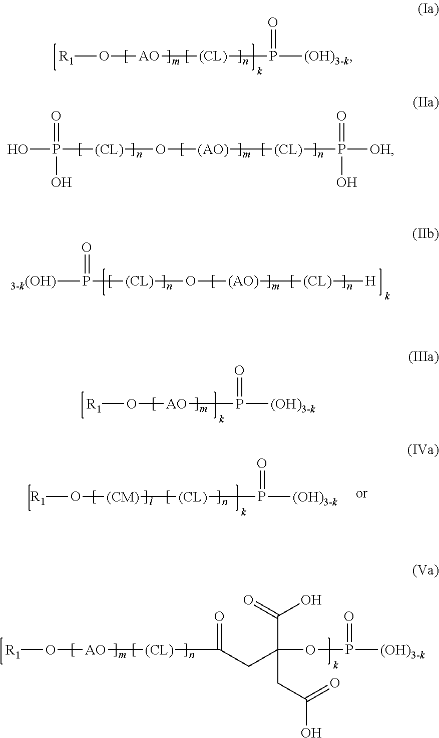

wherein

AO is the residue from ethylene oxide or propylene oxide;

CL is the residue from caprolactone;

CM is the residue from caprolactame;

R₁ is C₁-C₂₂alkyl;

k is a number 1 or 2;

l is a number from 3 to 15, preferably 4 to 9

m is a number from 3 to 15, preferably 4 to 9 and

n is a number from 2 to 10, preferably 2 to 7.

Examples for the compounds of formula Ia, IIa, IIb, IIIa, IVa and Va are compounds according to the formulae I′a, II′a, IIb, III′a, IV′a and V′a

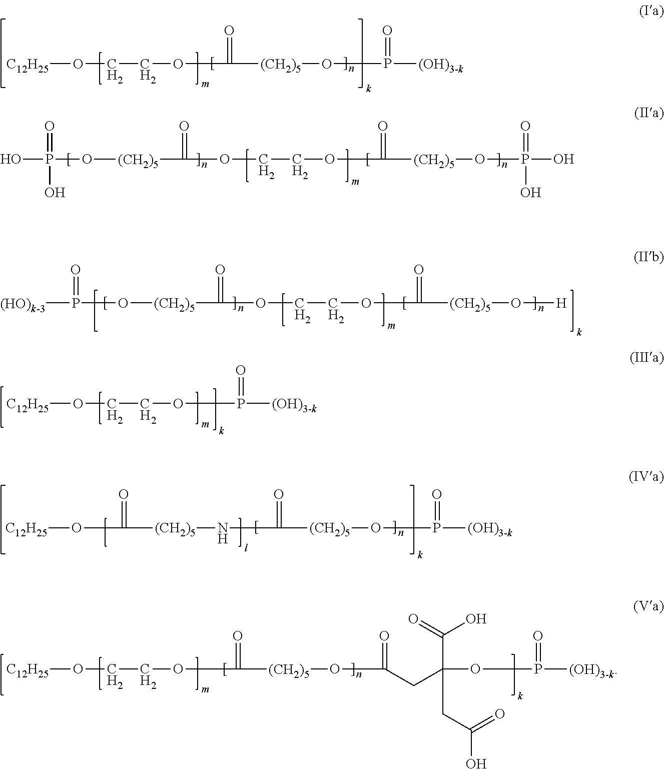

The compounds according to formulae Va and V′a are part of the genus of formula (I) above.

For instance the composition contains a polymeric phosphoric acid mono or diester which is a compound of formulae (Ia), (IIa), (IIb), (IIIa), (IVa) or (Va)

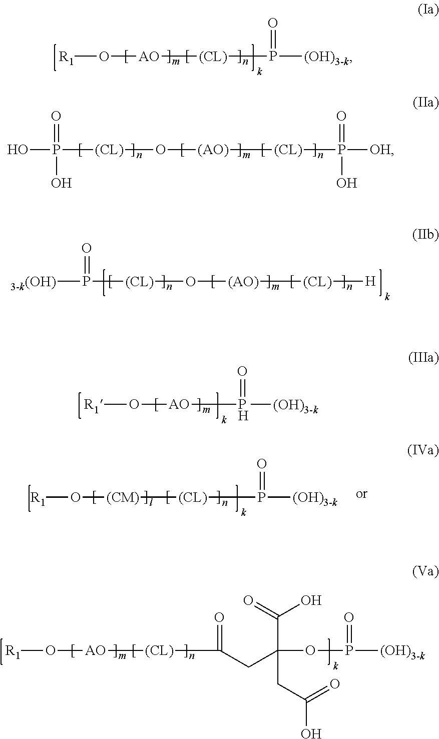

wherein

AO is the residue from ethylene oxide or propylene oxide;

CL is the residue from caprolactone;

CM is the residue from caprolactame;

R₁ is C₁-C₂₂alkyl;

R₁′ is C₁-C₁₀alkyl;

k is a number 1 or 2;

l is a number from 3 to 15, preferably 4 to 9

m is a number from 3 to 15, preferably 4 to 9 and

n is a number from 2 to 10, preferably 2 to 7.

Examples for the compounds of formula Ia, IIa, IIb, IIIa, IVa and Va are compounds according to the formulae I′a, II′a, IIb, III′a, IV′a and V′a

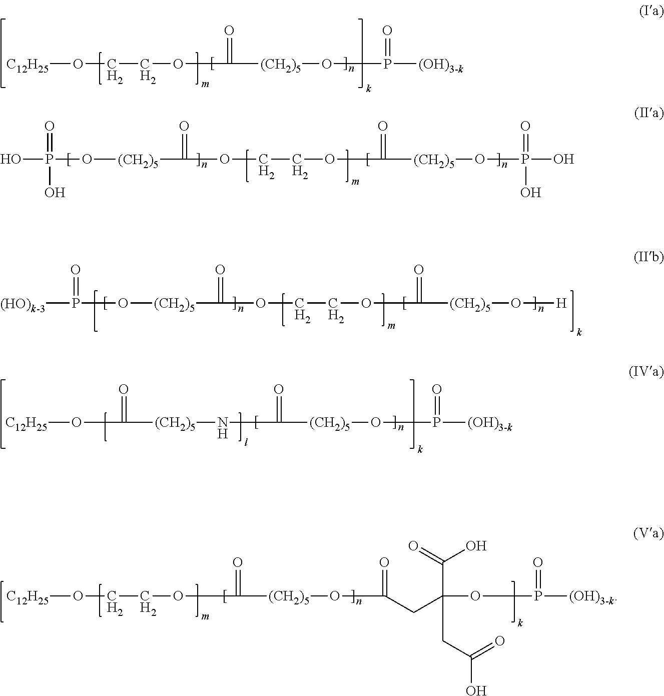

Examples of commercially available suitable phosphoric acid esters are, for example, BYK-W 9010, EFKA-8510, EFKA-8511, EFKA-8512 and the like.

Preferably the polyetheresteramide of component b), i) is present in an amount of from 0.1% to 30% by weight, based on the weight of the polymer substrate and the phosphoric acid derivative copolymer of component b, ii) is present in an amount of from 0.1% to 10% by weight, based on the weight of the polymer substrate.

The ratio between the polyetheresteramide and the phosphoric acid derivative copolymer is preferably from 20:1 to 1:1, more preferably from 10:1 to 2:1. The total amount of both components is preferably from 5% to 25%, more preferably from 8% to 18% by weight, based on the weight of the polymer substrate.

The antistatic polymer composition may comprise further additives. Those further additives belong especially to the group of the antioxidants, UV absorbers and/or light stabilisers. The thermal stabilisation covers both processing and use (long-term stability). Those further additives are known to the person skilled in the art and are for the most part commercially available.

Suitable antioxidants are, for example:

1. Alkylated monophenols, for example 2,6-di-tert-butyl-4-methylphenol, 2-butyl-4,6-dimethyl-phenol, 2,6-di-tert-butyl-4-ethylphenol, 2,6-di-tert-butyl-4-n-butylphenol, 2,6-di-tert-butyl-4-isobutylphenol, 2,6-di-cyclopentyl-4-methylphenol, 2-(α-methylcyclohexyl)-4,6-dimethyl-phenol, 2,6-di-octadecyl-4-methylphenol, 2,4,6-tri-cyclohexylphenol, 2,6-di-tert-butyl-4-methoxymethylphenol, 2,6-di-nonyl-4-methylphenol, 2,4-dimethyl-6-(1′-methyl-undec-1′-yl)-phenol, 2,4-dimethyl-6-(1′-methyl-heptadec-1-yl)-phenol, 2,4-dimethyl-6-(1′-methyl-tridec-1-yl)-phenol, octylphenol, nonylphenol and mixtures thereof.

2. Alkylthiomethylphenols, for example 2,4-di-octylthiomethyl-6-tert-butylphenol, 2,4-di-octylthiomethyl-6-methylphenol, 2,4-di-octylthiomethyl-6-ethylphenol, 2,6-di-dodecylthio-methyl-4-nonylphenol.

3. Hydroquinones and alkylated hydroquinones, for example 2,6-di-tert-butyl-4-methoxy-phenol, 2,5-di-tert-butyl-hydroquinone, 2,5-di-tert-amyl-hydroquinone, 2,6-diphenyl-4-octa-decyloxyphenol, 2,6-di-tert-butyl-hydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl)adipate.

4. Hydroxylated thiodiphenyl ethers, for example 2,2′-thio-bis(6-tert-butyl-4-methylphenol), 2,2′-thio-bis(4-octylphenol), 4,4′-thio-bis(6-tert-butyl-3-methylphenol), 4,4′-thio-bis(6-tert-butyl-2-methylphenol), 4,4′-thio-bis(3,6-di-sec-amylphenol), 4,4′-bis(2,6-dimethyl-4-hydroxyphenyl)disulfide.

5. Alkylidene bisphenols, for example 2,2′-methylene-bis(6-tert-butyl-4-methylphenol), 2,2′-methylene-bis(6-tert-butyl-4-ethylphenol), 2,2′-methylene-bis[4-methyl-6-(α-methylcyclo-hexyl)-phenol], 2,2′-methylene-bis(4-methyl-6-cyclohexylphenol), 2,2′-methylene-bis(6-nonyl-4-methylphenol), 2,2′-methylene-bis(4,6-di-tert-butylphenol), 2,2′-ethylidene-bis(4,6-di-tert-butylphenol), 2,2′-ethylidene-bis(6-tert-butyl-4-isobutylphenol), 2,2′-methylene-bis[6-(α-methylbenzyl)-4-nonylphenol], 2,2′-methylene-bis[6-(α,α-dimethylbenzyl)-4-nonylphenol], 4,4′-methylene-bis(2,6-di-tert-butylphenol), 4,4′-methylene-bis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methyl-benzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis(4-hydroxyphenyl)propane, 2,2-bis(5-tert-butyl-4-hydroxy-2-methylphenyl)-4-n-dodecylmercapto-butane, 1,1,5,5-tetra(5-tert-butyl-4-hydroxy-2-methylphenyl)pentane.

6. O—, N— and S-benzyl compounds, for example 3,5,3′,5′-tetra-tert-butyl-4,4′-dihydroxy-dibenzyl ether, octadecyl-4-hydroxy-3,5-dimethylbenzyl-mercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxy-benzyl-mercaptoacetate.

7. Hydroxybenzylated malonates, for example dioctadecyl-2,2-bis(3,5-di-tert-butyl-2-hydroxy-benzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, di-[4-(1,1,3,3-tetramethylbutyl)-phenyl]-2,2-bis(3,5-di-tert-butyl-4-hydroxybenzyl)malonate.

8. Hydroxybenzyl aromatic compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetra-methylbenzene, 2,4,6-tris(3,5-di-tert-butyl-4-hydroxybenzyl)-phenol.

9. Triazine compounds, for example 2,4-bis-octylmercapto-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-d i-tert-butyl-4-hydroxy-phenylpropionyl)hexahydro-1,3,5-triazine, 1,3,5-tris(3,5-dicyclohexyl-4-hydroxybenzyl)iso-cyanurate.

10. Phosphonates, phosphites and phosphonites, for example dimethyl-2,5-di-tert-butyl-4-hydroxybenzyl phosphonate, diethyl-3,5-di-tert-butyl-4-hydroxybenzyl phosphonate, diocta-decyl-3,5-di-tert-butyl-4-hydroxybenzyl phosphonate, dioctadecyl-5-tert-butyl-4-hydroxy-3-methylbenzyl phosphonate, calcium salt of 3,5-di-tert-butyl-4-hydroxybenzylphosphonic acid monoethyl ester, triphenylphosphite, diphenylalkylphosphites, phenyldialkylphosphites, tris-(nonylphenyl)phosphite, trilaurylphosphite, trioctadecylphosphite, distearylpentaerythritol diphosphite, tris(2,4-di-tert-butylphenyl)phosphite, diisodecylpentaerythritol diphosphite, bis(2,4-di-tert-butylphenyl)pentaerythritol diphosphite, bis(2,6-di-tert-butyl-4-methylphenyl)-pentaerythritol diphosphite, bisisodecyloxy-pentaerythritol diphosphite, bis(2,4-di-tert-butyl-6-methylphenyl)pentaerythritol diphosphite, bis(2,4,6-tri-tert-butylphenyl)pentaerythritol diphosphite, tristearyl-sorbitol triphosphite, tetrakis(2,4-di-tert-butylphenyl)-4,4′-biphenylene diphosphonite, 6-isooctyloxy-2,4,8,10-tetra-tert-butyl-12H-dibenz[d,g]-1,3,2-dioxaphosphocine, 6-fluoro-2,4,8,10-tetra-tert-butyl-12-methyl-dibenz[d,g]1,3,2-dioxaphosphocine, bis(2,4-di-tert-butyl-6-methylphenyl)methylphosphite, bis(2,4-di-tert-butyl-6-methylphenyl)-ethylphosphite, (C₉H₁₉—C₆H₄)_{1.5}—P—(O'C₁₂₋₁₃H₂₅₋₂₇)_{1.5}.

11. Acylaminophenols, for example 4-hydroxylauric acid anilide, 4-hydroxystearic acid anilide, N-(3,5-di-tert-butyl-4-hydroxyphenyl)carbamic acid octyl ester.

12. Esters of β-(3,5-di-tert-butyl-4-hydroxyphenyl)-propionic acid with mono- or poly-hydric alcohols, such as, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalic acid diamide, 3-thiaundecanol, 3-thiapentadecanol, trimethyl-hexanediol, trimethylolpropane, 4-hydroxymethyl-1-phospha-2,6,7-trioxabicyclo[2.2.2]octane.

13. Esters of β-(5-tert-butyl-4-hydroxy-3-methylphenyl)-propionic acid with mono- or polyhydric alcohols, such as, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy)ethyl isocyanurate, N,N′-bis(hydroxyethyl)oxalic acid diamide, 3-thiaundecanol, 3-thiapentadecanol, trimethyl-hexanediol, trimethylolpropane, 4-hydroxymethyl-1-phospha-2,6,7-trioxabicyclo[2.2.2]octane.

14. Esters of β-(3,5-dicyclohexyl-4-hydroxyphenyl)-propionic acid with mono- or poly-hydric alcohols, such as, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy)ethyl isocyanurate, N,N′-bis(hydroxyethyl)oxalic acid diamide, 3-thiaundecanol, 3-thiapentadecanol, trimethylhexane-diol, trimethylolpropane, 4-hydroxymethyl-1-phospha-2,6,7-trioxabicyclo[2.2.2]octane.

15. Esters of 3,5-di-tert-butyl-4-hydroxyphenylacetic acid with mono- or poly-hydric alcohols, such as, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy)ethyl isocyanurate, N,N′-bis(hydroxyethyl)oxalic acid diamide, 3-thiaundecanol, 3-thiapentadecanol, trimethylhexane-diol, trimethylolpropane, 4-hydroxymethyl-1-phospha-2,6,7-trioxabicyclo[2.2.2]octane.

16. Amides of β-(3,5-di-tert-butyl-4-hydroxyphenyl)propionic acid, such as, for example, N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxy-phenylpropionyl)hydrazine.

17. Esters of thiodiacetic acid and thiodipropionic acid

Preferred are antioxidants of groups 5, 10 and 14, especially 2,2-bis(4-hydroxyphenyl)propane, esters of 3,5-di-tert-butyl-4-hydroxyphenylpropionic acid with octadecanol or pentaerythritol or tris-(2,4-di-tert-butylphenyl)-phosphite.

If desired, a mixture of antioxidants of different structures may also be used.

The antioxidants may be used in an amount of, for example, from 0.01 to 10, advantageously from 0.1 to 10, and especially from 0.1 to 5, parts by weight, based on 100 parts by weight of polymer.

Suitable UV-Absorbers and Light Stabilisers are, for Example:

1. 2-(2′-Hydroxyphenyl)-benzotriazoles, such as, for example, 2-(2′-hydroxy-5′-methylphenyl)-benzotriazole, 2-(3′,5′-di-tert-butyl-2′-hydroxyphenyl)-benzotriazole, 2-(5′-tert-butyl-2′-hydroxyphenyl)-benzotriazole, 2-(2′-hydroxy-5′-(1,1,3,3-tetramethylbutyl)phenyl)-benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chlorobenzotriazole, 2-(3′-sec-butyl-5′-tert-butyl-2′-hydroxy-phenyl)-benzotriazole, 2-(2′-hydroxy-4′-octyloxyphenyl)-benzotriazole, 2-(3′,5′-di-tert-amyl-2′-hydroxyphenyl)-benzotriazole, 2-(3′,5′-bis(α,α-dimethylbenzyl)-2′-hydroxyphenyl)-benzotriazole, mixture of 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)-benzotriazole, 2-(3′-tert-butyl-2′-hydroxy-5′-(2-octyloxycarbonylethyl)phenyl)-benzotriazole, 2-(3′-tert-butyl-5′-[2-(2-ethylhexyloxy)carbonylethyl]-2′-hydroxyphenylybenzotriazole, 2-(3′-dodecyl-2′-hydroxy-5′-methylphenyl)-benzotriazole, and 2-(3′-tert-butyl-2′-hydroxy-5′-(2-isooctyloxycarbonylethyl)phenyl-benzotriazole, 2,2′-methylene-bis[4-(1,1,3,3-tetramethylbutyl)-6-benzotriazol-2-yl-phenol]; transesterification product of 2-[3′-tert-butyl-5′-(2-methoxycarbonylethyl)-2-hydroxyphenyl]-benzotriazole with polyethylene glycol 300; [R—CH₂CH₂—COO(CH₂)₃]— in which R=3′-tert-butyl-4′-hydroxy-5′-2H-benzotriazol-2-yl-phenyl.

2. 2-Hydroxybenzophenones, such as, for example, the 4-hydroxy, 4-methoxy, 4-octyloxy, 4-decyloxy, 4-dodecyloxy, 4-benzyloxy, 4,2′,4′-trihydroxy, 2′-hydroxy-4,4′-dimethoxy derivative.

3. Esters of unsubstituted or substituted benzoic acids, such as, for example, 4-tert-butyl-phenylsalicylate, phenylsalicylate, octylphenylsalicylate, dibenzoylresorcinol, bis(4-tert-butyl-benzoyl)resorcinol, benzoylresorcinol, 3,5-di-tert-butyl-4-hydroxybenzoic acid 2,4-di-tert-butyl-phenyl ester, 3,5-di-tert-butyl-4-hydroxybenzoic acid hexadecyl ester, 3,5-di-tert-butyl-4-hydroxybenzoic acid octadecyl ester, 3,5-di-tert-butyl-4-hydroxybenzoic acid 2-methyl-4,6-di-tert-butylphenyl ester.

4. Acrylates, such as, for example, α-cyano-β,β-diphenylacrylic acid ethyl ester or isooctyl ester, α-methoxycarbonyl-cinnamic acid methyl ester, α-cyano-β-methyl-p-methoxy-cinnamic acid methyl ester or butyl ester, α-methoxycarbonyl-p-methoxy-cinnamic acid methyl ester, N-(β-methoxycarbonyl-β-cyanovinyl)-2-methyl-indoline.

5. Nickel compounds, such as, for example, nickel complexes of 2,2′-thio-bis[4-(1,1,3,3-tetramethylbutyl)phenol], such as the 1:1 or 1:2 complex, optionally with additional ligands, such as n-butylamine, triethanolamine or N-cyclohexyl-diethanolamine, nickel dibutyl dithiocarbamate, nickel salts of 4-hydroxy-3,5-di-tert-butylbenzylphosphonic acid monoalkyl esters, such as of the methyl or ethyl ester, nickel complexes of ketoximes, such as of 2-hydroxy-4-methylphenylundecyl ketoxime, nickel complexes of 1-phenyl-4-lauroyl-5-hydroxypyrazole, optionally with additional ligands.

6. Sterically hindered amines, such as, for example, bis(2,2,6,6-tetramethyl-piperidyl)-sebacate, bis(2,2,6,6-tetramethylpiperidyl)succinate, bis(1,2,2,6,6-pentamethylpiperidyl)-sebacate, n-butyl-3,5-di-tert-butyl-4-hydroxybenzylmalonic acid bis(1,2,2,6,6-pentamethyl-piperidyl)ester, condensation product of 1-hydroxyethyl-2,2,6,6-tetramethyl-4-hydroxy-piperidine and succinic acid, condensation product of N,N′-bis(2,2,6,6-tetramethyl-4-piperidyl)hexamethylenediamine and 4-tert-octylamino-2,6-dichloro-1,3,5-s-triazine, tris(2,2,6,6-tetramethyl-4-piperidyl)nitrilotriacetate, tetrakis(2,2,6,6-tetramethyl-4-piperidyl)-1,2,3,4-butanetetraoate, 1,1′-(1,2-ethanediyl)-bis(3,3,5,5-tetramethyl-piperazinone), 4-benzoyl-2,2,6,6-tetramethylpiperidine, 4-stearyloxy-2,2,6,6-tetramethylpiperidine, bis-(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, condensation product of N,N′-bis(2,2,6,6-tetramethyl-4-piperidyl)-hexamethylenediamine and 4-morpholino-2,6-dichloro-1,3,5-triazine, condensation product of 2-chloro-4,6-di(4-n-butylamino-2,2,6,6-tetramethylpiperidyl)-1,3,5-triazine and 1,2-bis(3-aminopropylamino)ethane, condensation product of 2-chloro-4,6-di(4-n-butylamino-1,2,2,6,6-pentamethyl-piperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)-pyrrolidine-2,5-dione, and Chimassorb966.

7. Oxalic acid diamides, such as, for example, 4,4′-di-octyloxy-oxanilide, 2,2′-di-octyloxy-5,5′-di-tert-butyl-oxanilide, 2,2′-di-dodecyloxy-5,5′-di-tert-butyl-oxanilide, 2-ethoxy-2′-ethyl-oxanilide, N,N′-bis(3-dimethylaminopropyl)oxalamide, 2-ethoxy-5-tert-butyl-2′-ethyl-oxanilide and a mixture thereof with 2-ethoxy-2′-ethyl-5,4′-di-tert-butyl-oxanilide, mixtures of o- and p-methoxy- and of o- and p-ethoxy-di-substituted oxanilides.

8. 2-(2-1-Hydroxyphenyl)-1,3,5-triazines, such as, for example, 2,4,6-tris(2-hydroxy-4-octyloxy-phenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxy-phenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxy-propyloxy)-phenyl]-4,6-bis(2,4-dimethylphenyl)-1,3,5-triazine, 2-[2-hydroxy-4-(2-hydroxy-3-octyloxy-propyloxy)phenyl]-4,6-bis(2,4-dimethylphenyl)-1,3,5-triazine.

Suitable peroxide-destroying compounds are, for example:

esters of β-thio-dipropionic acid, for example lauryl, stearyl, myristyl or tridecyl esters, mercaptobenzimidazole, the zinc salt of 2-mercaptobenzimidazole, zinc dibutyl-dithio-carbamate, dioctadecyl disulfide, pentaerythritol-tetrakis(β-dodecylmercapto)propionate and ethylene glycol bismercaptoacetate.

The above further additives are typically added in an amount from 0.1 to 5% by weight, based on the weight of the polymer substrate.

Another aspect of the invention is a process for the preparation of antistatically finished thermoplastic or elastomeric polymers which process comprises mixing an additive mixture comprising
i) at least one antistatic additive selected from the group consisting of the polyetheresteramides; and
ii) a phosphoric acid mono or diester comprising a mono- or di-alcohol residue which is copolymerized with an alkylene oxide or/and a lactam or/and a lactone or/and a hydroxyl fubctional multiacid or mixtures thereof;
with the proviso that polyoxyethylene lauryl ether phosphoric acid is excluded;
   as such or in the form of its individual components and together with optional further additives with said polymers in calenders, mixers, kneaders or extruders.

The preparation may be carried out in a manner known per se by mixing the said components and, if desired, further additives with the polymer using devices known per se, such as calenders, mixers, kneaders, extruders and the like. The additives may be added individually or in admixture with one another. It is also possible to use so-called master batches.

An antistatic thermoplastic polymer obtainable according to the present invention can be made into the desired form in known manner. Such processes include, for example, grinding, calendering, extruding, injection-moulding, sintering, compression/sintering or spinning, also extrusion blow-moulding, or processing according to the plastisol method. The antistatic thermoplastic polymer may also be processed to form foamed materials.

The invention relates also to the use of an additive mixture comprising
i) at least one antistatic additive selected from the group consisting of the polyetheresteramides and
ii) a phosphoric acid mono or diester comprising a mono- or di-alcohol residue which is copolymerized with an alkylene oxide or/and a lactam or/and a lactone or/and a hydroxyl fubctional multiacid or mixtures thereof;
with the proviso that polyoxyethylene lauryl ether phosphoric acid is excluded;
   for the preparation of an antistatic thermoplastic or elastomeric polymer.

The following examples illustrate the invention

Compounds used:

Irgastat P18® from Ciba Inc. is a composition containing a polyetheresteramide,

BYK-W 9010® from BYK-Chemie GmbH,

BYK-W 995® from BYK-Chemie GmbH,

EFKA 8510 from Ciba Inc.,

Compound 101 is the compound of example 3 of WO 2005/085261.

Polymer Substrates:

| | |
|---|---|
| Polypropylene (PP) | Moplen HP 552R(RTM) from |
| | LyondellBasell Ind. |
| | (MFR 25 g/10 min, 2.16 kg, 230° C.) |
| Polyethylethylene (PE-HD) | M 800063S from SABIC Inc. |
| | (MFR 8.0 g/10 min, 2.16 kg, 190° C.) |
| Polyethylene (PE-LD) | Riblene FF 29 from Polimeri Europa |
| | (0.6 g/10 min, 2.16 kg, 190° C.) |
| Impact polystyrene (HIPS) | Styron 485 from Dow Plastics Inc |

Preparation of the Polymer Compounds

The formulations containing the resin (pellets or powder), IRGASTAT P 18 (0 to 20%) and the other additives (0 to 5% dissolved in ethanol) are blended in a high speed mixer. The mixtures are dried for 4 hours in a circulating air oven at 80° C. The compounding is performed with a twin screw extruder at appropriate temperature between 200 to 230° C.

The polypropylene samples contain a base stabilization of 0.15% Irganox B215® from Ciba Inc. and 0.05% Ca-stearate by weight, based on the weight of the polymer

Sample Preparation

a) Injection Molded Samples

Plaques of the size 90×85×2 mm are prepared by injection molding. The processing temperature is in the range of 220 to 240° C., depending on the resin.

b) Blown Films

Monolayer films with a thickness of 0.15 mm are blown at 200° C.

Testing of Surface and Volume Resistivity

The surface and volume resistivity are measured according to ASTM D257. The measurement is done with a test voltage of 500 V and a ring electrode.

Percentages given in the following Tables are by weight, based on the weight of the polymer substrate.

The results are presented in Tables 1-5

TABLE 1
Polypropylene, Moplen HP 552 R, Injection Molding

| | | Volume | Surface | Volume | Surface |
|---|---|---|---|---|---|
| | | Resistivity | Resistivity | Resistivity | Resistivity |
| | | (Ω × cm) at | (Ω/sq.) at | (Ω × cm) at | (Ω/sq.) at |
| No. | Additive | 50% r.h., 23° C. | 50% r.h., 23° C. | 15% r.h., 23° C. | 15% r.h., 23° C. |
| 1 | none | 9.7E+17 | 6.1E+16 | 2.3E+16 | 8.8E+15 |
| 2 | 5% IRGASTAT P 18 | 2.6E+16 | 2.9E+15 | 5.3E+15 | 5.3E+14 |
| 3 | 10% IRGASTAT P 18 | 1.2E+15 | 2.9E+15 | 6.4E+15 | 6.5E+12 |
| 4 | 15% IRGASTAT P 18 | 1.4E+13 | 3.0E+12 | 9.0E+12 | 6.1E+11 |
| 5 | 5% IRGASTAT P 18 + | 4.4E+14 | 5.1E+13 | 1.1E+15 | 3.4E+13 |
| | 1% EFKA 8510 | | | | |
| 6 | 5% IRGASTAT P 18 + | 2.7E+12 | 1.8E+11 | 4.5E+12 | 9.6E+11 |
| | 3% EFKA 8510 | | | | |
| 7 | 5% IRGASTAT P 18 + | 9.9E+11 | 8.8E+10 | 3.4E+12 | 1.9E+11 |
| | 5% EFKA 8510 | | | | |
| 8 | 10% IRGASTAT P 18 + | 1.3E+13 | 4.6E+11 | 1.7E+14 | 1.7E+12 |
| | 1% EFKA 8510 | | | | |
| 9 | 10% IRGASTAT P 18 + | 5.3E+11 | 1.8E+10 | 2.0E+12 | 1.2E+11 |
| | 3% EFKA 8510 | | | | |
| 10 | 10% IRGASTAT P 18 + | 1.1E+11 | 1.2E+10 | 4.1E+11 | 3.3E+10 |
| | 5% EFKA 8510 | | | | |

TABLE 2
Polyethylene PE-HD, M 80063, Injection Molding

| | | Volume | Surface | Volume | Surface |
|---|---|---|---|---|---|
| | | Resistivity | Resistivity | Resistivity | Resistivity |
| | | (Ω × cm) at | (Ω/sq.) at | (Ω × cm) at | (Ω/sq.) at |
| No. | Additive | 50% r.h., 23° C. | 50% r.h., 23° C. | 15% r.h., 23° C. | 15% r.h., 23° C. |
| 1 | 5% IRGASTAT P 18 | 4.6E+15 | 4.4E+14 | 8.8E+14 | 1.8E+14 |
| 2 | 10% IRGASTAT P 18 | 8.8E+14 | 1.5E+14 | 3.1E+14 | 6.5E+13 |
| 3 | 15% IRGASTAT P 18 | 4.1E+13 | 2.3E+12 | 6.2E+12 | 6.1E+11 |
| 4 | 5% IRGASTAT P 18 + | 1.5E+14 | 1.3E+13 | 5.5E+14 | 1.7E+13 |
| | 1% EFKA 8510 | | | | |
| 5 | 5% IRGASTAT P 18 + | 1.7E+12 | 7.5E+10 | 8.8E+12 | 5.2E+11 |
| | 3% EFKA 8510 | | | | |
| 6 | 5% IRGASTAT P 18 + | 1.7E+11 | 3.2E+10 | 7.4E+11 | 6.9E+10 |
| | 5% EFKA 8510 | | | | |
| 7 | 10% IRGASTAT P 18 + | 1.4E+13 | 6.4E+11 | 8.0E+12 | 7.2E+11 |
| | 1% EFKA 8510 | | | | |
| 8 | 10% IRGASTAT P 18 + | 1.8E+11 | 2.4E+10 | 1.9E+12 | 7.8E+10 |
| | 3% EFKA 8510 | | | | |
| 9 | 10% IRGASTAT P 18 + | 1.6E+11 | 9.2E+09 | 2.8E+11 | 4.4E+10 |
| | 5% EFKA 8510 | | | | |

TABLE 3
Polyethylene PE-LD, Riblene FF 29, Film

| | | Surface | Surface |
|---|---|---|---|
| | | Resistivity | Resistivity |
| | | (Ω/sq.) at | (Ω/sq.) at |
| No. | Additive | 50% r.h., 23° C. | 15% r.h., 23° C. |
| 1 | 1% EFKA 8510 | 9.2E+16 | 5.9E+15 |
| 2 | 3% EFKA 8510 | 1.8E+17 | 7.5E+15 |
| 3 | 12% IRGASTAT P 18 | 4.7E+12 | 5.9E+12 |
| 4 | 15% IRGASTAT P 18 | 7.6E+10 | 1.5E+11 |
| 5 | 18% IRGASTAT P 18 | 2.6E+10 | 5.4E+10 |
| 6 | 20% IRGASTAT P 18 | 1.4E+10 | 2.8E+10 |
| 7 | 12% IRGASTAT P 18 + | 1.1E+11 | 1.6E+11 |
| | 1% EFKA 8510 | | |
| 8 | 12% IRGASTAT P 18 + | 4.9E+10 | 1.2E+11 |
| | 3% EFKA 8510 | | |
| 9 | 15% IRGASTAT P 18 + | 2.0E+10 | 4.6E+10 |
| | 1% EFKA 8510 | | |
| 10 | 15% IRGASTAT P 18 + | 4.3E+10 | 1.0E+11 |
| | 3% EFKA 8510 | | |
| 11 | 18% IRGASTAT P 18 + | 7.5E+09 | 1.7E+10 |
| | 1% EFKA 8510 | | |
| 12 | 18% IRGASTAT P 18 + | 7.2E+09 | 1.3E+10 |
| | 3% EFKA 8510 | | |

TABLE 4
Impact Polystyrene (HIPS), Styron 485, Injection Molding

| | | Volume | Surface | Volume | Surface |
|---|---|---|---|---|---|
| | | Resistivity | Resistivity | Resistivity | Resistivity |
| | | (Ω × cm) at | (Ω/sq.) at | (Ω × cm) at | (Ω/sq.) at |
| No. | Additive | 50% r.h., 23° C. | 50% r.h., 23° C. | 15% r.h., 23° C. | 15% r.h., 23° C. |
| 1 | none | 5.7E+16 | 3.8E+15 | 1.2E+18 | 1.0E+16 |
| 2 | 5% IRGASTAT P 18 | 2.1E+14 | 4.1E+14 | 1.3E+17 | 9.2E+15 |
| 3 | 10% IRGASTAT P 18 | 2.6E+10 | 9.1E+10 | 4.9E+11 | 4.4E+12 |
| 4 | 15% IRGASTAT P 18 | 4.2E+9 | 1.2E+10 | 4.4E+10 | 3.0E+11 |
| 5 | 1% EFKA 8510 | 3.0E+17 | 3.7E+15 | 3.9E+16 | 8.9E+15 |
| 6 | 3% EFKA 8510 | 3.5E+16 | 3.8E+15 | 7.5E+16 | 1.3E+16 |
| 7 | 5% EFKA 8510 | 6.6E+16 | 4.4E+15 | 7.8E+16 | 1.1E+16 |
| 8 | 5% IRGASTAT P 18 + | 3.1E+16 | 2.0E+15 | 1.1E+17 | 8.7E+15 |
| | 1% EFKA 8510 | | | | |
| 9 | 5% IRGASTAT P 18 + | 5.4E+14 | 6.3E+14 | 5.5E+14 | 5.4E+14 |
| | 3% EFKA 8510 | | | | |
| 10 | 5% IRGASTAT P 18 + | 2.3E+14 | 1.5E+14 | 2.2E+14 | 1.6E+14 |
| | 5% EFKA 8510 | | | | |
| 11 | 10% IRGASTAT P 18 + | 1.8E+10 | 5.2E+10 | 2.8E+11 | 8.7E+11 |
| | 1% EFKA 8510 | | | | |
| 12 | 10% IRGASTAT P 18 + | 5.1E+10 | 2.3E+11 | 5.2E+11 | 3.2E+12 |
| | 3% EFKA 8510 | | | | |
| 13 | 10% IRGASTAT P 18 + | 8.4E+9 | 8.9E+10 | 9.0E+10 | 6.2E+11 |
| | 5% EFKA 8510 | | | | |

The above data clearly demonstrate that the combination of both additives results in a significant decrease of the resitivity which is higher than expected from each component alone.

TABLE 5
Polyethylene PE-HD, M 80063, Injection Molding

| | | Volume | Surface | Volume | Surface |
|---|---|---|---|---|---|
| | | Resistivity | Resistivity | Resistivity | Resistivity |
| | | (Ω × cm) at | (Ω/sq.) at | (Ω × cm) at | (Ω/sq.) at |
| No. | Additive | 50% r.h., 23° C. | 50% r.h., 23° C. | 15% r.h., 23° C. | 15% r.h., 23° C. |
| 1 | none | 1.4E+16 | 1.2E+16 | 1.0E+16 | 4.6E+15 |
| 2 | 5% IRGASTAT P 18 | 3.8E+15 | 3.1E+13 | 4.5E+15 | 2.0E+14 |
| 3 | 10% IRGASTAT P 18 | 7.4E+13 | 5.7E+11 | 1.3E+14 | 1.1E+12 |
| 4 | 15% IRGASTAT P 18 | 3.1E+12 | 7.3E+10 | 1.0E+13 | 1.1E+11 |
| 5 | 10% IRGASTAT P 18 + | 1.5E+13 | 1.3E+11 | 3.4E+13 | 4.7E+11 |
| | 1% comp. 101 | | | | |
| 6 | 10% IRGASTAT P 18 + | 3.3E+11 | 2.6E+10 | 1.1E+12 | 9.2E+10 |
| | 3% comp. 101 | | | | |
| 7 | 10% IRGASTAT P 18 + | 1.1E+13 | 1.4E+11 | 3.3E+13 | 3.1E+11 |
| | 1% BYK-W 995 | | | | |
| 8 | 10% IRGASTAT P 18 + | 4.3E+11 | 1.1E+10 | 1.8E+12 | 2.4E+10 |
| | 3% BYK-W 995 | | | | |
| 9 | 10% IRGASTAT P 18 + | 2.4E+12 | 5.8E+10 | 7.5E+12 | 1.8E+11 |
| | 1% BYK-W 9010 | | | | |
| 10 | 10% IRGASTAT P 18 + | 6.6E+10 | 9.0E+09 | 4.4E+11 | 3.0E+10 |
| | 3% BYK-W 9010 | | | | |

1. An antistatic polymer composition comprising
a) a thermoplastic or elastomeric polymer substrate and
b) a combination of
i) at least one antistatic additive selected from the group consisting of polyetheresteramides and
ii) a polymeric phosphoric acid mono or diester comprising a mono- or di-alcohol residue which is copolymerized with an alkylene oxide or/and a lactam or/and a lactone or/and a hydroxyl functional multiacid or mixtures thereof;
with the proviso that polyoxyethylene lauryl ether phosphoric acid is excluded.

2. A composition according to claim 1, wherein component (a) is a polyolefin, a polystyrene, a copolymer of acrylonitrile/butadiene/styrene, a polymer of α,β-unsaturated acids, a halogen-containing polymer, a homo- or co-polymer of cyclic ethers, a polymer of unsaturated alcohols and amines, a polyacetal, a polyphenylene oxide, a polyurethane, a polyamide, a polyester, a polyurea, a polycarbonate, a polysulfone or natural rubber.

3. A composition according to claim 2, wherein component (a) is a polyolefin, a polystyrene, an acrylonitrile/butadiene/styrene copolymer, a polymer of α,β-unsaturated acids, a halogen-containing polymer or a homo- or co-polymer of cyclic ethers.

4. A composition according to claim 3, wherein component (a) is polyvinyl chloride, polyethylene, polystyrene or polypropylene.

5. A composition according to claim 1 in which the polyetheresteramides are aliphatic polyetheresteramides.

6. A composition according to claim 1 wherein the polyetheresteramide consists essentially of residues derived from (1) a polyamide oligomer having carboxylic end groups and having a number average molecular weight of from about 200 to about 15,000 and (2) a polyoxyalkylene glycol having a number average molecular weight of from about 200 to about 6,000.

7. A composition according to claim 1 wherein the polyetheresteramide is part of a mixture comprising
a) 0-80 parts, of a fibrous polyamide
b) 100 15 parts of a polyetherester amide and
c) 0-5 parts of an ionic compound selected from the group consisting of an alkaline metal salt of acetic acid, trifluoroacetic acid, methanesulfonic acid,
trifluoromethane sulfonic acid, dodecylbenzene sulfonic acid, toluenesulfonicacid, alkylsulfonic acids ardor ether sulfonic acids, LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF6)₂ and Ca(CF₃SO₃),
wherein the sum of components a), b) and c) being 100 parts.

8. A composition according to claim 1 wherein the polyetheresteramide is part of a mixture comprising
a) 20-80 parts of a fibrous polyamide
b) 80-20 parts of a polyetherester amide and
c) 0.5-5 parts of an ionic compound selected from the group consisting of an alkaline metal salt of acetic acid, trifluoroacetic acid, methanesulfonic acid, trifluoromethane sulfonic acid, dodecylbenzene sulfonic acid, toluenesulfonicacid, alkylsulfonic acids ether sulfonic acids, LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF6)₂ and Ca(CF₃SO₃)₄,
wherein the sum of components a), b) and c) being 100 parts.

9. A composition according to claim 1 wherein the polymeric phosphoric acid mono or diester is a compound of formula I, 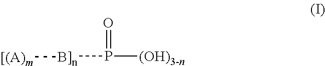
wherein
A is a monohydroxyl residue derived from
C₁-C₂₀-alkyl-(AO)x-OH or Acyl-(AO)x-OH; or
C₁-C₂₀-alkyl-(AO)x-(HA)y-OH or Acyl-(AO)x-(HA)y-OH; or
C₁-C₂₀-alkyl-(AO)x-(AA-AO)y-OH or Acyl-(AO)x-(AA-AO)y-OH; or
MO-(HA)y-OH or MO-(AA-AO)y-OH; wherein
Acyl is an aromatic carboxylic acid residue or a saturated or unsaturated fatty acid residue;
AO is a polyC₂-C₄alkyleneglycol residue,
HA is a hydroxycarboxylic acid or a lactone thereof,
AA is a dicarboxylic acid,
MO is a monoalcohol,
x is 1 to 250,
Y is 1 to 250,
B is a mono-, di-, tri- or polyhydroxy, di-, tri- or multi-carboxylic acid residue which is linked via the hydroxy group to the phosphoric acid and via one of the carboxylic acid groups to the monohydroxyl residue [A], the remaining carboxylic acid group(s) is/are free or is/are esterified with a further monohydroxyl residue [A], resulting in branched esters;
n is 1-2; and
m is 1-4.

10. A composition according to claim 1 wherein the polymeric phosphoric acid mono or diester is a compound of formulae (Ia), (IIa), (IIb), (IIIa), (IVa) or (Va) 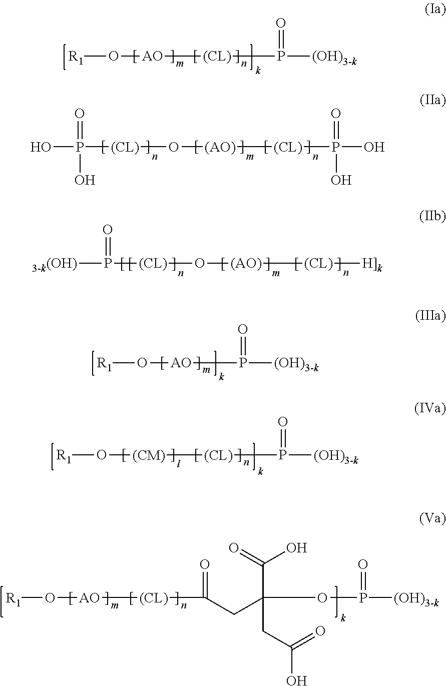
wherein
AO is a residue from ethylene oxide or propylene oxide;
CL is a residue from caprolactone;
CM is the residue from caprolactame;
R₁ is C₁-C₂₂alkyl;
k is a number 1 or 2;
l is a number from 3 to 15,
m is a number from 3 to 15, and
n is a number from 2 to 10.

11. A composition according to claim 1 wherein the polyetheresteramide of component b), i) is present in an amount of from 0.1% to 30% by weight, based on the weight of the polymer substrate and the polymeric phosphoric acid mono or diester of component b, ii) is present in an amount of from 0.1% to 10% by weight, based on the weight of the polymer substrate.

12. A process for the preparation of antistatically finished thermoplastic or elastomeric polymers which process comprises mixing an additive mixture comprising
i) at least one antistatic additive selected from the group consisting of polyetheresteramides; and
ii) a polymeric phosphoric acid mono or diester comprising a mono- or di-alcohol residue which is copolymerized with an alkylene oxide or/and a lactam or/and a lactone or/and a hydroxyl functional multiacid or mixtures thereof;
with the proviso that polyoxyethylene lauryl ether phosphoric acid is excluded;
as such or in the form of its individual components and together with optional further additives with said polymers in calenders, mixers, kneaders or extruders.

13. (canceled)
